(19) United States
(12) Patent Application Publication
(10) Pub. No.: US 2010/0231349 A1
(43) Pub. Date: Sep. 16, 2010

(54) COMMUNICATION DEVICE AND COMMUNICATION METHOD

(75) Inventor: Akitomo Tanaka, Amagasaki-shi (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shi (JP)

(21) Appl. No.: 12/708,186

(22) Filed: Feb. 18, 2010

(30) Foreign Application Priority Data
Mar. 13, 2009 (JP) P2009-060956

(51) Int. Cl. G06F 7/04

(52) U.S. Cl. 340/5.2; 340/825.36

(57) ABSTRACT

A communication method of a communication device for performing communication with an in-vehicle device includes determining whether or not the communication device is within a predetermined storage region, and performing a control of prohibiting transmission and reception of signals with the in-vehicle device when determined that the communication device is within the predetermined storage region.

### BACKGROUND OF THE INVENTION

1. Technical Field

The present invention relates to communication devices and communication methods, and in particular, to a communication device and a communication method enabling unauthorized use of a vehicle by a person other than a legitimate user to be prohibited.

2. Related Art

In recent years, a so-called passive entry system (PES) for automatically performing locking and unlocking of a door in a hands-free manner is put to practical use for the entry system of the vehicle, and more widespread use is expected in the future.

The passive entry system automatically realizes operation (unlocking operation and locking operation) of the locking mechanism of the vehicle door through control of the in-vehicle device by performing bi-directional wireless communication between a portable device that can be carried around by the user and the in-vehicle device, and performing check on the authenticity of the portable device, analysis on the position etc. of the portable device and the like based on an electromagnetic wave (signal) received from the portable device by the in-vehicle device.

The passive entry system will be described with reference to FIG. 1.

In the passive entry system of FIG. 1, a bi-directional wireless communication is carried out between an in-vehicle device 12 mounted on a vehicle 11 and a portable device 13 carried around by the user. The vehicle 11 includes an antenna connected with the in-vehicle device 12 at the door knob, the trunk, the compartment etc. of the vehicle, and the respective antennas transmit a signal of LF wave (e.g., 100 to 200 KHz) as necessary. An LF communication area 14 in which the in-vehicle device 12 and the portable device 13 can communicate thereby is formed at the periphery of the antennas.

When the portable device 13 enters the LF communication area 14, the portable device 13 receives the signal of the LF wave and responds thereto, and the in-vehicle device 12 receives a signal transmitted from the portable device 13, whereby communication is carried out between the in-vehicle device 12 and the portable device 13. In the passive entry system, when the user operates a switch (not shown) arranged on the outer side of the door of the vehicle 11 to unlock the door, the door is unlocked if the unlock operation is performed by a legitimate user as a result of performing the communication between the in-vehicle device 12 and the portable device 13.

Assume that the vehicle 11 is parked in a parking lot, and the user moves to a room adjacent to the parking lot with the portable device 13, as shown in FIG. 2. In this case, if the portable device 13 is placed at a distance communicable with the in-vehicle device 12 through a window 15 of the room, the door of the vehicle may be unlocked according to the operation of unlocking the door by a person other than the user.

For instance, Japanese Unexamined Patent Publication No. 2003-178032 discloses a technique of prohibiting unauthorized use of the vehicle by a person other than the legitimate user by combining an authentication process performed between the in-vehicle device and the portable device, and an authentication by biometrics information of the legitimate user.

### SUMMARY

However, the prevention of the unauthorized use of the vehicle by a person other than the legitimate user with a method simpler than the method of using the biometrics information is desired.

One or more embodiments of the present prevent unauthorized use of the vehicle by a person other than a legitimate user.

In accordance with one aspect of the present invention, there is provided a communication device for performing communication with an in-vehicle device, the communication device including a transmission unit for transmitting signals to the in-vehicle device; a reception unit for receiving signals from the in-vehicle device; a determination unit for determining whether or not the communication device is within a predetermined storage region; and a control unit for performing a control of prohibiting the transmission and the reception of signals with the in-vehicle device by the transmission unit or the reception unit when determined that the communication device is within the predetermined storage region by the determination unit.

In accordance with another aspect of the present invention, there is provided a communication method of a communication device for performing communication with an in-vehicle device, the communication method including the steps of determining whether or not the communication device is within a predetermined storage region; and performing a control of prohibiting the transmission and the reception of signals with the in-vehicle device when determined that the communication device is within the predetermined storage region.

In one aspect of the present invention, whether or not the communication device is within the predetermined storage region is determined, and a process of prohibiting the transmission and the reception of signals with the in-vehicle device is performed when determined that the communication device is within the predetermined storage region.

Thus, the authentication process with the in-vehicle device is avoided from being performed against the intention of the user when the communication device is within the predetermined storage region, and unauthorized use of the vehicle by a person other than the legitimate user can be prevented.

A connection detection unit for detecting connection with a charger for charging the communication device may be further arranged; wherein the determination unit determines that the communication device is within the predetermined storage region when the connection with the charger is detected by the connection detection unit.

The communication device can be reliably detected that the communication device is within the predetermined storage region.

A signal detection unit for detecting a signal output at a passage through which the signal passes when entering and exiting the predetermined storage region may be further arranged; wherein the determination unit determines whether or not the communication device is within the predetermined storage region based on the signal detected by the signal detection unit.

The transmission and the reception of signals with the in-vehicle device thus can be prohibited by simply passing through the passage, thereby saving the trouble of the user.

The control unit may prohibit the transmission and the reception of the signals with the in-vehicle device by stopping at least either the transmission of signals by the transmission unit or the reception of signals by the reception unit. An inhibiting signal emitting unit for emitting an inhibiting signal for inhibiting the signal output from the transmission unit may be further arranged, wherein the control unit prohibits the transmission and the reception of signals with the in-vehicle device by emitting the inhibiting signal for inhibiting the signal output from the transmission unit from the inhibiting signal emitting unit.

Thus, the transmission and the reception of signals with the in-vehicle device can be reliably prohibited.

A warning unit for making a warning when the reception unit receives the signal from the in-vehicle device while the transmission and the reception of signals with the in-vehicle device are prohibited by the control unit may be further arranged.

Thus, the security with respect to stealing of the vehicle can be enhanced.

According to one aspect of the present invention, unauthorized use of the vehicle by a person other than the legitimate user can be prevented.

### BRIEF DESCRIPTION OF THE DRAWINGS

FIG. 1 is a view describing a passive entry system;

FIG. 2 is a view describing a state in which a door of a vehicle is unlocked against the intention of the user;

FIG. 3 is a block diagram showing a configuration example of a portable device applied with one embodiment of the present invention;

FIG. 4 is a view describing the connection between the portable device and a charger;

FIG. 5 is a flowchart describing a process of prohibiting unauthorized use of the vehicle by the portable device;

FIG. 6 is a block diagram showing a configuration example of the portable device and the charger;

FIG. 7 is a flowchart describing a process of preventing unauthorized use of the vehicle by the portable device and the charger;

FIG. 8 is a view describing an LF communication area; and

FIG. 9 is a flowchart describing a process of preventing unauthorized use of the vehicle using the LF communication area.

### DETAILED DESCRIPTION

In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. Hereinafter, embodiments of the present invention will be described with reference to the drawings.

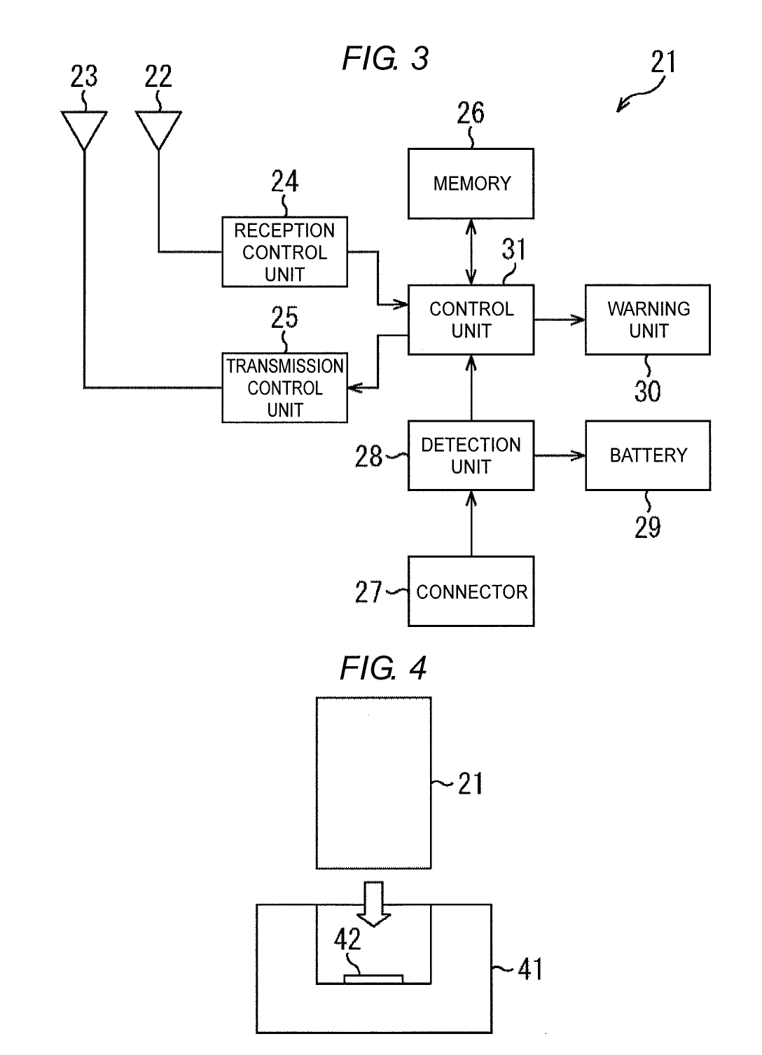

FIG. 3 is a block diagram showing a configuration example of a portable device applied with an embodiment of the present invention.

In FIG. 3, a portable device 21 is configured to include antennas 22 and 23, a reception control unit 24, a transmission control unit 25, a memory 26, a connector 27, a detection unit 28, a battery 29, a warning unit 30, and a control unit 31.

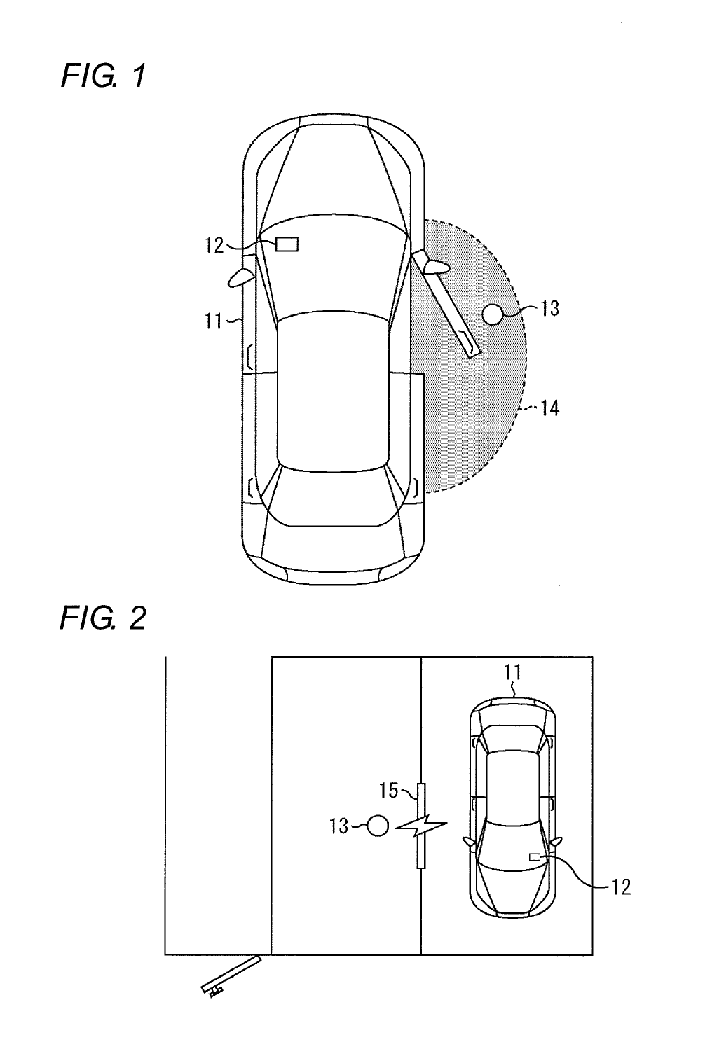

The antennas 22 and 23 are configured to transmit and receive electric waves of different frequency bands, where the antenna 22 is configured to receive the electric wave of LF (Low Frequency) band, and the antenna 23 is configured to transmit the electric wave of UHF (Ultra High Frequency) band. The antenna 22 receives the electric wave transmitted from the in-vehicle device 12 (FIG. 1) and provides a signal corresponding to such electric wave to the reception control unit 24, whereas the antenna 23 transmits the electric wave corresponding to the signal provided from the transmission control unit 25.

The reception control unit 24 demodulates the signal provided from the antenna 22 and provides the demodulated signal to the control unit 31. The transmission control unit 25 modulates the signal provided from the control unit 31 according to the control of the control unit 31 and provides the modulated signal to the antenna 23.

The memory 26 is configured as an EEPROM (Electrically Erasable Programmable Read-Only Memory), and the like, and appropriately stores a vehicle ID (Identification) for specifying the vehicle 11, necessary information, and the like.

The connector 27 is used to connect the portable device 21 to a charger. For instance, if a charger 41 shown in FIG. 4 is installed at a predetermined storage area in a room of the user of the portable device 21 and the user places the portable device 21 on the charger 41 along the direction of the arrow in FIG. 4, the connector 27 of the portable device 21 is connected to a connector 42 of the charger 41. The portable device 21 and the charger 41 thus can be electrically connected through the connectors 27 and 42 by placing the portable device 21 on the charger 41.

When the portable device 21 is connected to the charger 41 through the connector 27, the detection unit 28 detects the connection with the charger 41 and provides a detection signal indicating the connection to the control unit 31. When the portable device 21 and the charger 41 are disconnected, the detection unit 28 detects the disconnection with the charger 41 and provides the detection signal indicating the disconnection to the control unit 31.

The battery 29 supplies power to each part of the portable device 21. The battery 29 receives the power from the charger 41 connected through the connector 27 through the detection unit 28, and is charged by such power.

The warning unit 30 includes an alarm for outputting a warning sound, a small liquid crystal display, and the like, and makes a warning to the user by outputting the warning sound or displaying a warning message (message indicating that the LF wave is received in an unintended state of the user) according to the control of the control unit 31.

The control unit 31 is a so-called a microcomputer configured by a CPU (Central Processing Unit), a ROM (Read Only Memory), a RAM (Random Access Memory), and the like, and controls the operation of the portable device 21 when the CPU develops the program stored in the ROM in the RAM and executes the program.

For instance, the in-vehicle device 12 of FIG. 1 transmits a request signal for starting an authentication process necessary for unlocking the door when a switch arranged on the outer side of the door of the vehicle 11 is operated. If the position of the portable device 21 is within the LF communication area 14, the reception control unit 24 receives the request signal, and provides the same to the control unit 31. The control unit 31 reads out the vehicle ID stored in the memory 26 in response to the request signal, generates an answer signal including the vehicle ID, and transmits the answer signal through the transmission control unit 25. Alternatively, the control unit 31 may transmit the ID etc. unique to the portable device 21 as the answer signal.

Furthermore, when the portable device 21 is connected to the charger 41 (FIG. 4) by the user and the detection signal indicating the connection with the charger 41 is provided from the detection unit 28, the control unit 31 controls the transmission control unit 25 to stop the function of transmitting signals. Thereafter, when the portable device 21 and the charger 41 are disconnected and the detection signal indicating the disconnection with the charger 41 is provided from the detection unit 28, the control unit 31 controls the transmission control unit 25 and activates the function of transmitting signals. Thus, the transmission of the answer signal, and the like from the portable device 21 is prohibited while the function of transmitting signals is stopped.

In other words, if the charger 41 is installed in the room of the user and the portable device 21 is connected to the charger 41, this means that the portable device 21 is in the room. In this case, since the portable device 21 is in a stored state when the user does not have an intention of using the vehicle 11 and the portable device 21 is in the room, the interior of the room may be referred to as the storage region of the portable device 21. Therefore, the transmission of signals from the portable device 21 is prohibited when the portable device 21 is in the storage region.

Moreover, the control unit 31 controls the warning unit 30 and makes a warning to the user when the reception control unit 24 receives signals from the in-vehicle device 12 shown in FIG. 1 while the portable device 21 is connected to the charger 41. For instance, assume that the in-vehicle device 12 transmits the request signal for starting the authentication process necessary for unlocking the door and the reception control unit 24 receives the request signal while the portable device 21 is connected to the charger 41. The portable device 21 is not connected to the charger 41 since when the user unlocks the door of the vehicle 11, the portable device 21 is normally carried around. Therefore, when the reception control unit 24 receives the request signal with the portable device 21 connected to the charger 41, this means that the operation is performed by a person other than the legitimate user.

In this case, the control unit 31 controls the warning unit 30 and notifies the user that the operation by a person other than the legitimate user is performed by outputting the warning sound from the alarm or displaying the warning message on the small liquid crystal display arranged in the warning unit 30. The warning unit 30 may perform both the output of the warning sound and the display of the warning message, or may perform either one.

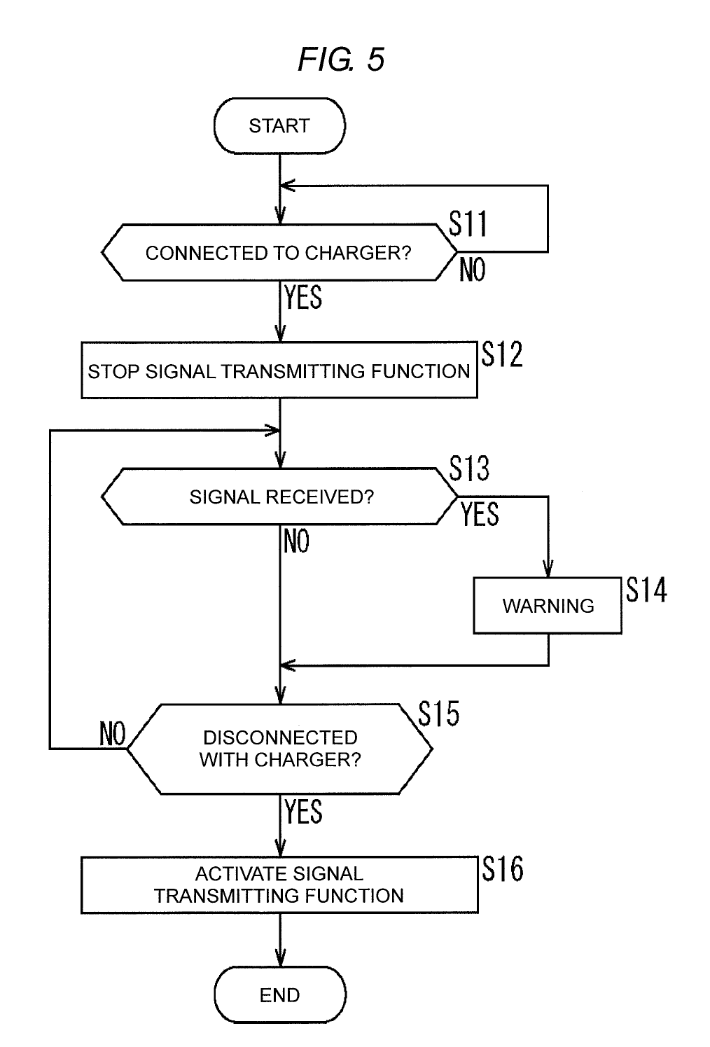

FIG. 5 is a flowchart describing a process of prohibiting unauthorized use of the vehicle 11 by the portable device 21.

The process starts when the user locks the door of the vehicle 11 using the passive entry system, where the control unit 31 determines whether or not the portable device 21 is connected to the charger 41 in step S11, and the process waits until determined that the portable device 21 is connected to the charger 41.

Thereafter, when the portable device 21 is connected to the charger 41 by the user and the detection unit 28 provides the detection signal indicating the connection with the charger 41 to the control unit 31, the control unit 31 determines that the portable device 21 is connected to the charger 41 instep S11, and the process proceeds to step S12.

In step S12, the control unit 31 controls the transmission control unit 25 to stop the function of transmitting signals. The transmission of signals from the portable device 21 is thereby prohibited. The control unit 31 turns ON the function of making the warning when the reception control unit 24 receives the signal.

The process proceeds to step S13 after the process of step S12, and the control unit 31 determines whether or not the reception control unit 24 received the request signal.

If the control unit 31 determines that the reception control unit 24 received the request signal, that is, if the request signal received by the reception control unit 24 is provided in step S13, the process proceeds to step S14, and the control unit 31 controls the warning unit 30 to make a warning to the user.

The process proceeds to step S15 after the process of step S14, or when the control unit 31 determines that the reception control unit 24 did not receive the request signal in step S13, and the control unit 31 determines whether or not the portable device 21 and the charger 41 are disconnected.

If the control unit 31 determines that the portable device 21 and the charger 41 are not disconnected in step S15, the process returns to step S13, and similar processes are repeated.

If the control unit 31 determines that the portable device 21 and the charger 41 are disconnected in step S15, the process proceeds to step S16. For instance, when the detection unit 28 detects the disconnection with the charger 41, and provides the detection signal indicating the disconnection to the control unit 31, the control unit 31 determines that the portable device 21 and the charger 41 are disconnected.

In step S16, the control unit 31 controls the transmission control unit 25 to activate the function of transmitting signals. The control unit 31 turns OFF the function of making the warning when the reception control unit 24 receives the signal, and terminates the process.

Therefore, the communication with the in-vehicle device 12 is prohibited according to the connection with the charger 41 in the portable device 21, so that unauthorized use of the vehicle 11 by a person other than the legitimate user can be prevented when the portable device 21 is connected with the charger 41, that is, when the portable device 21 is in the room. Thus, the unlocking of the door of the vehicle 11 by a person other than the legitimate user can be prevented, and the vehicle 11 is prevented from being stolen.

The warning is made by the warning unit 30 to call the attention of the user, and the security with respect to the stealing of the vehicle 11 can be enhanced.

The portable device 21 may not have the warning function using the warning unit 30, and may simply stop the function of transmitting signals when connected to the charger 41. In other words, the authentication process between the portable device 21 and the in-vehicle device 12 is not performed by simply prohibiting the transmission of signals from the portable device 21, and thus the door of the vehicle 11 will not be unlocked and the vehicle 11 is prevented from unauthorized usage.

For instance, in addition to stopping the function of transmitting signals, a function where the reception control unit 24 receives the signal (LF signal) transmitted from the vehicle 11 may be stopped in the portable device 21. The control unit 31 may stop the function where the reception control unit 24 receives the LF signal when determined that the portable device 21 is connected to the charger 41 in step S11 of FIG. 5. Thus, the authentication process between the portable device 21 and the in-vehicle device 12 is not performed even by stopping the function where the reception control unit 24 receives the LF signal, whereby the vehicle 11 is prevented from unauthorized usage.

In addition to connecting the portable device 21 to the charger 41, when the portable device 21 is placed in the communication area of the non-contact communication device (not shown) installed in the room using the non-contact close range communication, the function of transmitting signals can be stopped.

Furthermore, the inhibiting electric wave of the same band as the signal transmitted from the transmission control unit 25 may be emitted and the reception of the signal by the in-vehicle device 12 of FIG. 1 may be prevented by the inhibiting electric wave.

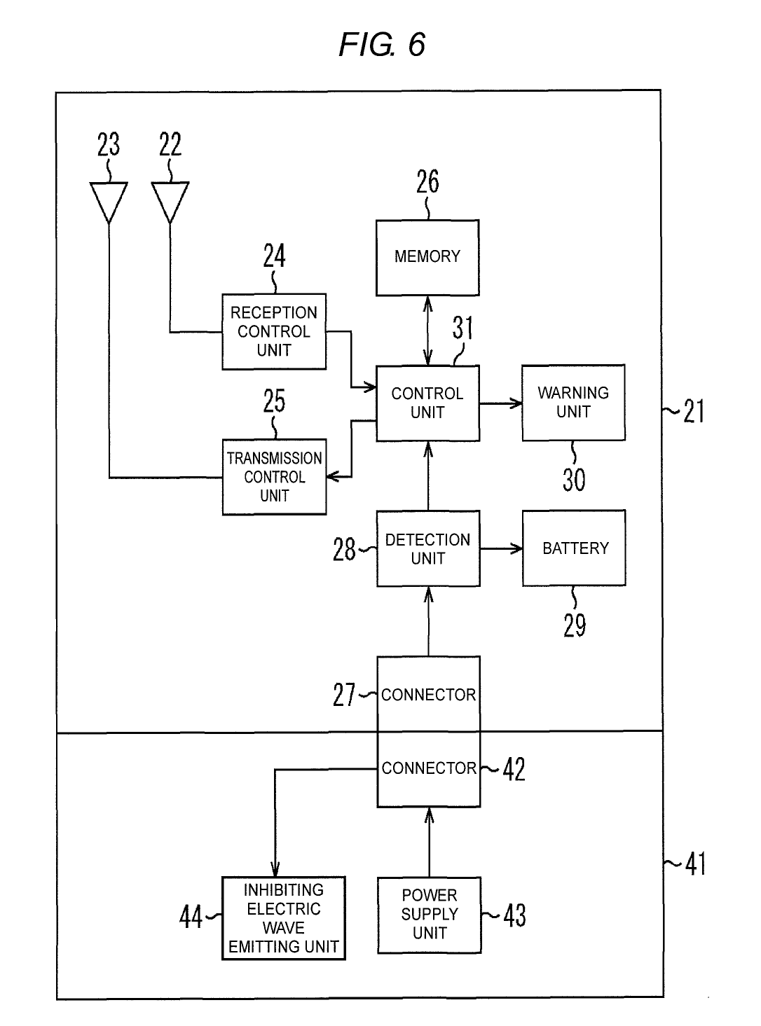

An example of emitting the inhibiting electric wave from the charger 41 will be described with reference to FIG. 6.

FIG. 6 is a block diagram of the portable device 21 and the charger 41. The portable device 21 of FIG. 6 has the same configuration as the portable device 21 of FIG. 3.

The charger 41 of FIG. 6 is configured to include a connector 42, a power supply unit 43, and an inhibiting electric wave emitting unit 44.

The connector is connected with the connector 27 of the portable device 21 to electrically connect the portable device 21 and the charger 41. The power supply unit 43 supplies power to the battery 29 through the connectors 27 and 42 and charges the battery 29. The inhibiting electric wave emitting unit 44 emits the inhibiting electric wave according to the control of the control unit 31 through the connectors 27 and 42.

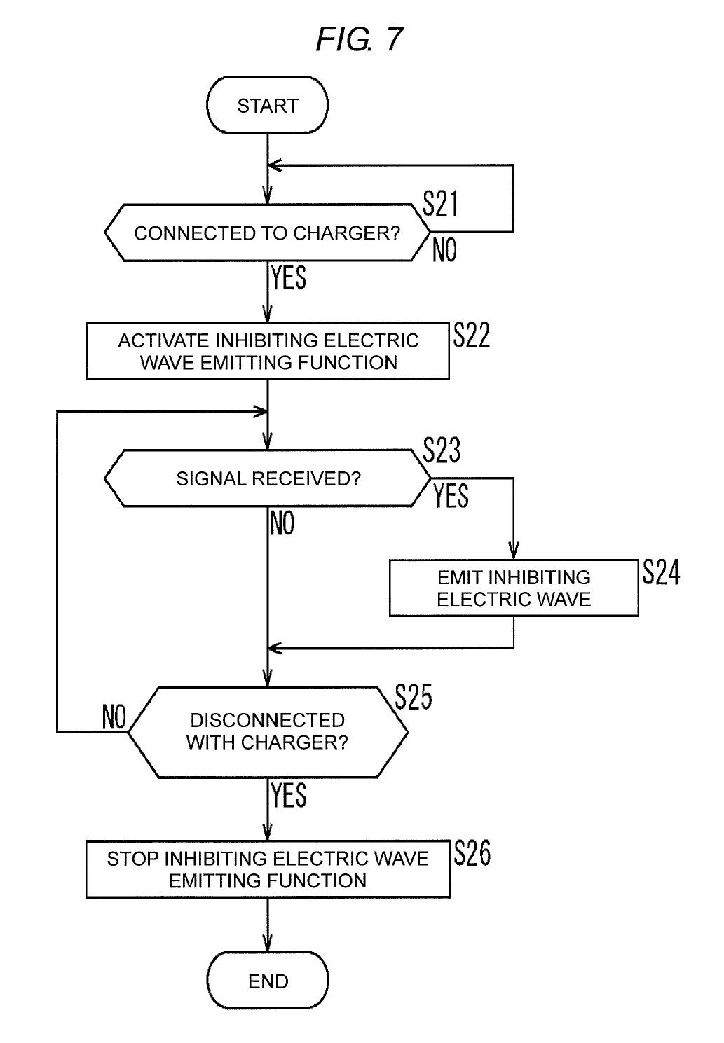

A process of preventing unauthorized use of the vehicle 11 by the portable device 21 and the charger 41 will be described below with reference to FIG. 7.

For instance, the process starts when the user locks the door of the vehicle 11 using the passive entry system, the control unit 31 determines whether or not the portable device 21 is connected to the charger 41 and waits for the process until determined that the portable device 21 is connected to the charger 41 in step S21, similar to the process of step S11 of FIG. 5.

If the control unit 31 determines that the portable device 21 is connected to the charger 41 in step S21, the process proceeds to step S22.

In step S22, the control unit 31 controls the inhibiting electric wave emitting unit 44 through the connectors 27 and 42, and activates the function of emitting the inhibiting electric wave and also turns ON the function of making a warning when the reception control unit 24 receives the signal.

The process proceeds to step S23 after the process of step S22, and the control unit 31 determines whether or not the reception control unit 24 received the request signal, where the process proceeds to step S24 if determined that the reception control unit 24 received the request signal.

In step S24, the control unit 31 controls the inhibiting electric wave emitting unit 44 to emit the inhibiting electric wave. With this, the in-vehicle device 12 is inhibited from receiving the answer signal by the inhibiting electric wave emitted from the inhibiting electric wave emitting unit 44 even if the transmission control unit 25 transmits the answer signal in response to the request signal, and the authentication process is prohibited from being performed between the portable device 21 and the in-vehicle device 12. The control unit 31 controls the warning unit 30 to make a warning to the user.

The process proceeds to step S25 after the process of step S24 or when the control unit 31 determines that the reception control unit 24 did not receive the request signal in step S23, and the control unit 31 determines whether or not the portable device 21 and the charger 41 are disconnected.

If the control unit 31 determines that the portable device 21 and the charger 41 are not disconnected in step S25, the process returns to step S23, and similar processes are repeated.

If the control unit 31 determines that the portable device 21 and the charger 41 are disconnected in step S25, the process proceeds to step S26, and the control unit 31 controls the inhibiting electric wave emitting unit 44 to stop the function of emitting the inhibiting electric wave. The control unit 31 turns OFF the function of making a warning when the reception control unit 24 receives the signal.

Therefore, the unauthorized use of the vehicle 11 by the person other than the legitimate user can be prevented since the communication with the in-vehicle device 12 can be prohibited even by emitting the inhibiting electric wave from the inhibiting electric wave emitting unit 44.

For instance, since the function of transmitting the signal is stopped when the portable device 21 is in the room other than when the portable device 21 is connected to the charger 41, the unauthorized use of the vehicle 11 can be prevented.

For instance, the LF transmitter for outputting the LF wave may be installed at the entrance (passage) through which the user passes to go in and out of the house, and the control unit 31 may determine whether or not the portable device 21 is in the room using the LF communication area by the LF wave output from the LF transmitter. The control unit 31 can stop the function of transmitting the signal according to such determination.

In other words, two LF transmitters (not shown) are installed at the entrance so that the LF communication area 52 are generated on the outer side of the door 51 arranged at the entrance of the house of the user, and the LF communication area 53 is generated on the inner side of the door 51. In this case, the control unit 31 determines whether the portable device 21 moved into the room or moved out of the room based on the order the portable device 21 passed through the LF communication areas 52 and 53 when the user carrying the portable device 21 passes through the entrance.

For instance, when the reception control unit 24 receives the LF wave in the LF communication area 52, specifically, receives the response request signal including the ID of the Lf transmitter forming the LF communication area 52, and then receives the LF wave in the LF communication area 53 within a constant time (time of an extent the user passes through the entrance), determination is made that the portable device 21 moved from outside the room to inside the room. When the reception control unit 24 receives the LF wave in the LF communication area 52 within a constant time after receiving the LF wave in the LF communication area 53, determination is made that the portable device 21 moved from inside the room to outside the room.

When the reception control unit 24 simply receives the LF wave in the LF communication area 52 and does not receive the signal thereafter within the constant time, determination is made that the portable device 21 is outside the room. When the reception control unit 24 simply receives the LF wave in the LF communication area 53 and does not receive the signal thereafter within the constant time, determination is made that the portable device 21 is in the room. In such cases, the function related to the transmission of the signals from the portable device 21 is not changed.

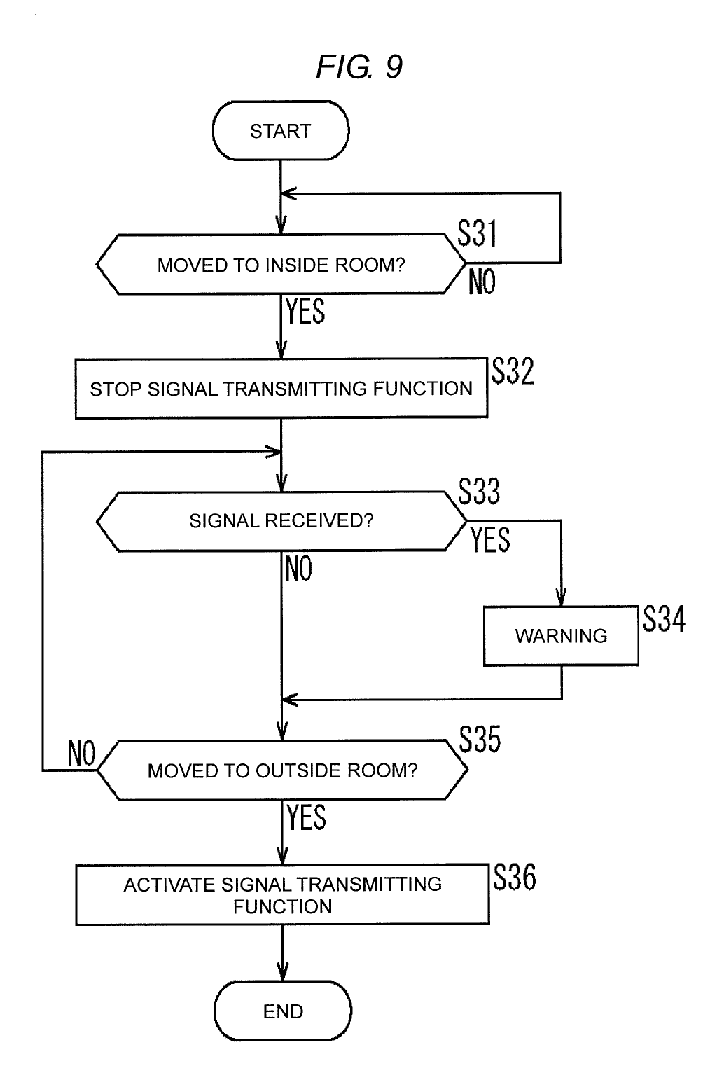

FIG. 9 is a flowchart describing a process of preventing unauthorized use of the vehicle 11 using the LF communication areas 52 and 53.

The process starts when the user locks the door of the vehicle 11 using the passive entry system, where the control unit 31 determines whether or not the portable device 21 moved from outside the room to inside the room in step S31, and the process waits until determined that the portable device 21 moved from outside the room to inside the room.

As described above, when the reception control unit 24 receives the LF wave in the LF communication area 53 within the constant time after receiving the LF wave in the LF communication area 52, the control unit 31 determines that the portable device 21 moved from outside the room to inside the room in step S31, and the process proceeds to step S32.

The processes of steps S32 to S34 are similar to the processes of steps S12 to S14 of FIG. 5, and the description thereof will be omitted.

The process proceeds to step S35 after the process of step S34, or when the control unit 31 determines that the reception control unit 24 did not receive the request signal in step S33, and the control unit 31 determines whether or not the portable device 21 moved from inside the room to outside the room.

If the control unit 31 determines that the portable device 21 did not move from inside the room to outside the room in step S35, the process returns to step S33, and similar processes are repeated.

When the reception control unit 24 receives the LF wave in the LF communication area 52 within the constant time after receiving the LF wave in the LF communication area 53, the control unit 31 determines that the portable device 21 moved from inside the room to outside the room in step S35, and the process proceeds to step S36.

Similar to step S16 of FIG. 5, in step S36, the control unit 31 controls the transmission control unit 25 to activate the function of transmitting signals, and turns OFF the function of making the warning when the reception control unit 24 receives the signal, and terminates the process.

Therefore, since the communication with the in-vehicle device 12 is prohibited using the LF communication areas 52 and 53, the trouble of connecting to the charger 41 to prohibit the communication with the in-vehicle device 12 and the like can be omitted, and the communication with the in-vehicle device 12 can be reliably prohibited.

The portable device 21 may be built with the inhibiting electric wave emitting unit 44 of FIG. 6, and the authentication process between the portable device 21 and the in-vehicle device 12 may be prohibited when the control unit 31 controls the inhibiting electric wave emitting unit 44 built in the portable device 21 to activate the function of emitting the inhibiting electric wave when determined that the portable device 21 moved from outside the room to inside the room.

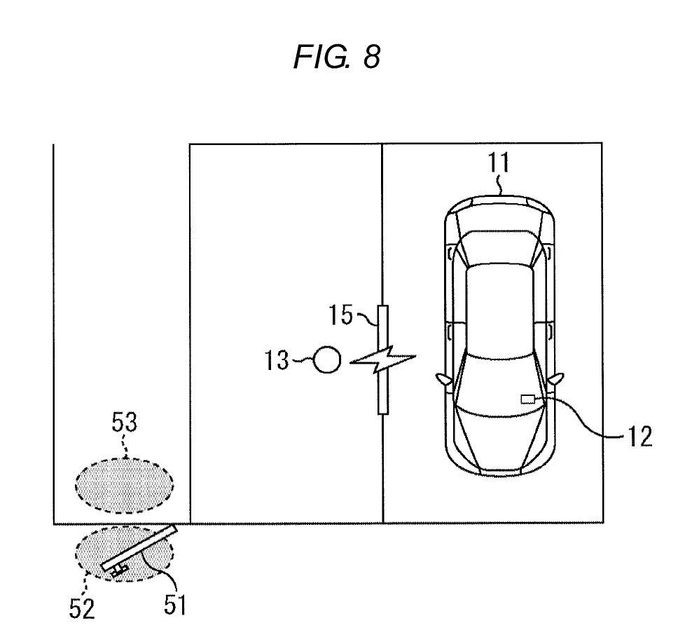

When the portable device 21 is also used as a key to the house, and the door 51 (FIG. 8) can be locked and unlocked using the portable device 21, the communication with the in-vehicle device 12 may be prohibited according to the operation of unlocking the door 51 by the portable device 21.

Each process described with reference to the above-described flowcharts does not necessarily need to be processed in time-series along the order described in the flowchart, and may include processes executed in parallel or individually (e.g., parallel process or process by object). The program may be processed by one CPU, or may be distributed by a plurality of CPUs.

The present invention is not limited to the embodiment described above, and various modifications may be made without deviating from the scope of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A communication device for performing communication with an in-vehicle device, the communication device comprising:
a transmission unit for transmitting signals to the in-vehicle device;
a reception unit for receiving signals from the in-vehicle device;
a determination unit for determining whether or not the communication device is within a predetermined storage region; and
a control unit for performing a control of prohibiting the transmission and the reception of signals with the in-vehicle device by the transmission unit or the reception unit when a determination is made that the communication device is within the predetermined storage region by the determination unit.

2. The communication device according to claim 1, further comprising:
a connection detection unit for detecting connection with a charger for charging the communication device;
wherein the determination unit determines that the communication device is within the predetermined storage region when the connection with the charger is detected by the connection detection unit.

3. The communication device according to claim 1, further comprising:
a signal detection unit for detecting a signal output at a passage through which the signal passes when entering and exiting the predetermined storage region; wherein
the determination unit determines whether or not the communication device is within the predetermined storage region based on the signal detected by the signal detection unit.

4. The communication device according to claim 1, wherein the control unit prohibits the transmission and the reception of the signals with the in-vehicle device by stopping at least either the transmission of signals by the transmission unit or the reception of signals by the reception unit.

5. The communication device according to claim 1, further comprising:
an inhibiting signal emitting unit for emitting an inhibiting signal for inhibiting the signal output from the transmission unit, wherein
the control unit prohibits the transmission and the reception of signals with the in-vehicle device by emitting the inhibiting signal for inhibiting the signal output from the transmission unit from the inhibiting signal emitting unit.

6. The communication device according to claim 1, further comprising:
a warning unit for making a warning when the reception unit receives the signal from the in-vehicle device while the transmission and the reception of signals with the in-vehicle device are prohibited by the control unit.

7. A communication method of a communication device for performing communication with an in-vehicle device, the communication method comprising the steps of:
determining whether or not the communication device is within a predetermined storage region; and
performing a control of prohibiting transmission and reception of signals with the in-vehicle device when a determination is made that the communication device is within the predetermined storage region.

8. The communication method according to claim 7, further comprising:
detecting connection with a charger for charging the communication device, thereby determining that the communication device is within the predetermined storage region.

9. The communication method according to claim 7, further comprising:
detecting a signal output at a passage through which the signal passes when entering and exiting the predetermined storage region, and
determining whether or not the communication device is within the predetermined storage region based on the detected signal.

10. The communication method according to claim 7, further comprising:
prohibiting the transmission and the reception of the signals with the in-vehicle device by stopping at least either the transmission of signals or the reception of signals.

11. The communication method according to claim 7, further comprising:
emitting an inhibiting signal for inhibiting the signal output from the transmission unit, thereby prohibiting the transmission and the reception of signals with the in-vehicle device.

12. The communication method according to claim 7, further comprising:
making a warning when the signal from the in-vehicle device is received while the transmission and the reception of signals with the in-vehicle device are prohibited.
